(19) United States
(12) Patent Application Publication
(10) Pub. No.: US 2017/0279326 A1
(43) Pub. Date: Sep. 28, 2017

(54) Silicon steel sheet for motor

(71) Applicant: Ming-Chang LEE, Taipei City (TW)

(72) Inventor: Ming-Chang LEE, Taipei City (TW)

(21) Appl. No.: 15/079,056

(22) Filed: Mar. 24, 2016

(51) Int. Cl. H02K 3/32; H02K 1/06

(52) U.S. Cl. CPC H02K 3/325; H02K 1/06

(57) ABSTRACT

A silicon steel sheet for a motor contains: a peripheral extension, a plurality of main teeth, multiple auxiliary teeth, a plurality of first pole shoes, and multiple second pole shoes. Each main tooth is separated from each auxiliary tooth and is defined between any two auxiliary teeth, each first pole shoe is in connection with each main tooth, and each second pole shoe is coupled with each auxiliary tooth. Said each first pole shoe, said each second pole shoe, said each main tooth, and said each auxiliary tooth define an accommodation space configured to house at least one electrical wire. Preferably, at least one electrical wire is winded on said each main tooth and said each auxiliary tooth, respectively.

### FIELD OF THE INVENTION

The present invention relates to a silicon steel sheet for a motor which reduces a length of at least one electrical wire winded on each main tooth and each auxiliary tooth, respectively.

### BACKGROUND OF THE INVENTION

At present, a brushless DC motor replaces conventional DC motor and conventional AC motor which are applicable for printers, sports apparatus, air conditioners, fans and digital equipment, etc.

The brushless DC motor contains a rotor and a stator on which at least one electrical wire is winded. After conducting electricity, the at least one electrical wire produces electromagnetic interaction by which the rotor is driven to swivel relative to the stator. The stator contains a plurality of silicon steel sheets stacked together.

Each silicon steel sheet has a peripheral extension on which multiple teeth are formed, and between any two teeth is defined an accommodation space, and each tooth has a pole shoe arranged on a free end thereof, wherein any two pole shoes of said any two teeth are spaced by an opening, such that the at least one electrical wire is housed in the accommodation space via the opening.

However, angles of the multiple teeth are identical, respectively, so a number of winding circles of the at least one electrical wire is too high to reduce a length of the at least one electrical wire.

Furthermore, as the motor rotates, the silicon steel sheet makes noises loudly and causes vibration.

The present invention has arisen to mitigate and/or obviate the afore-described disadvantages.

### SUMMARY OF THE INVENTION

The primary objective of the present invention is to provide a silicon steel sheet for a motor which reduces a length of at least one electrical wire winded on each main tooth and each auxiliary tooth, respectively.

Another objective of the present invention is to provide a silicon steel sheet for a motor in which each first pole shoe has two first cutouts, and each second pole shoe has two second cutouts, and a distance between each first cutout and an opening adjacent to said each first cutout is fixed, a distance between each second cutout and the opening adjacent to said each second cutout is fixed so as to decrease cogging torque, vibration and noise as the motor rotates.

To obtain above-mentioned objectives, a silicon steel sheet for a motor provided by the present invention contains: a peripheral extension, a plurality of main teeth, multiple auxiliary teeth, a plurality of first pole shoes, and multiple second pole shoes. Each main tooth is separated from each auxiliary tooth and is defined between any two auxiliary teeth, each first pole shoe is in connection with each main tooth, and each second pole shoe is coupled with each auxiliary tooth. Said each first pole shoe, said each second pole shoe, said each main tooth, and said each auxiliary tooth define an accommodation space configured to house at least one electrical wire. Preferably, at least one electrical wire is winded on said each main tooth and said each auxiliary tooth, respectively.

Preferably, a ratio of a first length of said each main tooth against a second length of said each auxiliary tooth is 10:7.

Preferably, the first length of said each main tooth is 10 mm, and the second length of said each auxiliary tooth is 7 mm

Preferably, said each first pole shoe has two first cutouts, and said each second pole shoe has two second cutouts.

### BRIEF DESCRIPTION OF THE DRAWINGS

FIG. 1 is a side plan view showing the assembly of a silicon steel sheet for a motor according to a preferred embodiment of the present invention.

### DETAILED DESCRIPTION OF THE PREFERRED EMBODIMENTS

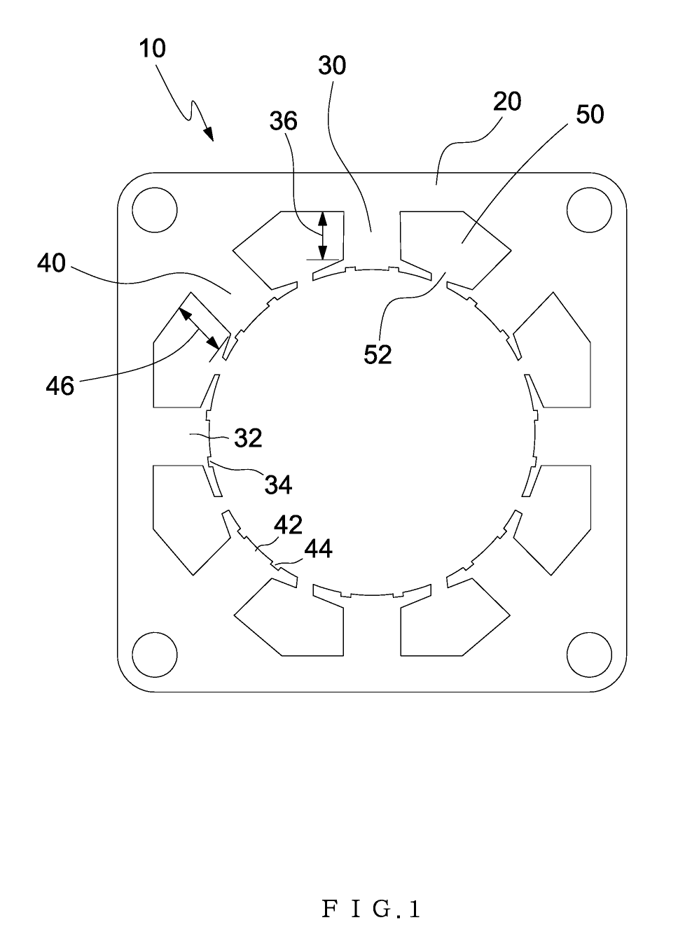

With reference to FIG. 1, a silicon steel sheet 10 for a motor according to a preferred embodiment of the present invention is polygonal and has a thickness of 13 mm The silicon steel sheet 10 comprises: a peripheral extension 20, a plurality of main teeth 30, multiple auxiliary teeth 40, a plurality of first pole shoes 32, and multiple second pole shoes 42.

Each main tooth 30 is separated from each auxiliary tooth 40 and is defined between any two auxiliary teeth 40, each first pole shoe 32 is in connection with said each main tooth 30, and each second pole shoe 42 is coupled with said each auxiliary tooth 40. Said each first pole shoe 32, wherein said each second pole shoe 42, said each main tooth 30, and said each auxiliary tooth 40 define an accommodation space 50 configured to house at least one electrical wire (not shown). Between said each first pole shoe 32 and said each second pole shoe 42 is defined an opening 52 so that the at least one electrical wire is housed in the accommodation space 50 via the opening 52.

A first length 36 of said each main tooth 30 is 10 mm, and a second length 46 of said each auxiliary tooth 40 is 7 mm, so a ratio of the first length 36 against the second length 46 is 10:7, thus reducing a length of at least one electrical wire winded on said ach main tooth 30 and said each auxiliary tooth 40, respectively.

In addition, said each first pole shoe 32 has two first cutouts 34, said each second pole shoe 42 has two second cutouts 44, and a distance between each first cutout 34 and the opening 50 adjacent to said each first cutout 34 is fixed, a distance between each second cutout 44 and the opening 50 adjacent to said each second cutout 44 is fixed so as to decrease cogging torque, vibration and noise as the motor rotates.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A silicon steel sheet for a motor comprising: a peripheral extension, a plurality of main teeth, multiple auxiliary teeth, a plurality of first pole shoes, and multiple second pole shoes;
wherein each main tooth is separated from each auxiliary tooth and is defined between any two auxiliary teeth, each first pole shoe is in connection with each main tooth, and each second pole shoe is coupled with each auxiliary tooth;
wherein said each first pole shoe, said each second pole shoe, said each main tooth, and said each auxiliary tooth define an accommodation space configured to house at least one electrical wire; and
wherein at least one electrical wire is winded on said ach main tooth and said each auxiliary tooth, respectively.

2. The silicon steel sheet for the motor as claimed in claim 1, wherein a ratio of a first length of said each main tooth against a second length of said each auxiliary tooth is 10:7.

3. The silicon steel sheet for the motor as claimed in claim 2, wherein the first length of said each main tooth is 10 mm, and the second length of said each auxiliary tooth is 7 mm

4. The silicon steel sheet for the motor as claimed in claim 1, wherein said each first pole shoe has two first cutouts, and said each second pole shoe has two second cutouts.
